(19) United States
(12) Patent Application Publication
(10) Pub. No.: US 2026/0015900 A1
(43) Pub. Date: Jan. 15, 2026

(54) SLIDER ASSEMBLY FOR ADJUSTING GLASS IN FRAMELESS SIDE WINDOW REGULATOR

(71) Applicant: SHIGEKI ARIMOTO, Bloomfield Hills, MI (US)

(72) Inventor: SHIGEKI ARIMOTO, Bloomfield Hills, MI (US)

(21) Appl. No.: 18/769,659

(22) Filed: Jul. 11, 2024

(51) Int. Cl. E05F 11/42

(52) U.S. Cl. CPC E05F 11/423; E05Y 2900/55

(57) ABSTRACT

A slider assembly for adjusting glass in frameless side window regulators includes a slider base, a glass retainer, and a back plate, with the glass retainer connected to the slider base and the back plate supporting both, ensuring the assembly is securely attached to the glass. A cam, pre-assembled on the slider base, features multiple serrations that engage with the slider base in a pre-assembled condition to support the bottom edge of the glass. A spring tab, integrally connected to the glass retainer, holds the cam on the slider base using a frictional force. Upon operation, the spring tab releases this frictional force, pushing the cam towards the slider base, and allows the cam to rotate. This rotation facilitates precise and secure positioning of the glass during adjustments.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter pertains to a slider assembly used in vehicle systems for adjusting glass panels. More particularly, the present disclosure relates to a slider assembly designed for adjusting glass in frameless side window regulators, enabling precise and secure positioning of the glass with manual operational control.

### BACKGROUND

The disclosed subject matter pertains to the field of automotive window systems, particularly to mechanisms used to adjust and secure glass in vehicles. Vehicle windows, especially those in doors, play a critical role in providing comfort, security, and functionality to passengers and drivers alike. In frameless window systems, where the window glass is not surrounded by a visible frame when the door is closed, precise adjustment and secure positioning of the glass are even more critical due to the lack of structural framing.

In traditional systems, adjusting the position of the window glass to ensure a perfect fit against the vehicle body's header seal is often a manual and cumbersome process. To align the top edge of the glass with the header seal on the body, the glass must be physically manipulated—grabbed, moved, and held by hand—while the glass attachment bolt is retightened. This method is not only time-consuming and inefficient but also requires significant manual effort, which can lead to inconsistent results and potential damage to the glass or discomfort to the operator.

Furthermore, the need to manually hold the glass in position until the attachment is secured poses several challenges. It increases the risk of misalignment or slippage, leading to gaps or poor sealing with the header seal, which compromises both the aesthetic and the functional integrity of the window system. This manual process lacks precision and does not cater to the need for a more refined, controlled adjustment mechanism.

To overcome these challenges, there is a pressing need for a slider assembly that allows for the adjustment and secure positioning of the glass without the need to manually hold the glass. This invention addresses the need for a mechanism that can precisely control the glass position, allowing for a seamless fit to the top edge of the glass against the header seal. By automating the adjustment process and removing the need for manual holding, the slider assembly improves the installation and adjustment process, enhancing the overall integrity and functionality of the frameless side window regulator.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The objective of this disclosure is to design a slider assembly designed for adjusting glass in frameless side window regulators, enabling precise and secure positioning of the glass with manual operational control.

Another objective of the present disclosure is to provide a slider assembly that enables precise adjustment of glass in frameless side window regulators without requiring the glass to be manually held in place during adjustment.

Another objective of the present disclosure is to eliminate the need for manual intervention, reducing the risk of misalignment and ensuring a more efficient and user-friendly adjustment process.

Yet another objective of the present disclosure is to facilitate secure and stable positioning of the glass once the desired adjustment has been made.

Another objective of the present disclosure is to enhance the overall safety and reliability of the window adjustment process.

Yet another objective of the present disclosure is to improve the ease of installation and maintenance of the window regulator system.

Another objective of the present disclosure is to optimize the ergonomic design of the window adjustment mechanism to enhance user interaction.

Yet another objective of the present disclosure is to reduce the wear and tear on the components of the window regulator mechanism.

Another objective of the present disclosure is to provide a window adjustment mechanism that can be easily adapted to various vehicle designs and specifications.

According to an exemplary aspect of the present disclosure, the slider assembly comprises a slider base, a glass retainer, and a back plate, where the glass retainer is connected to the slider base. This configuration ensures that the glass is securely held and allows for precise adjustments. The back plate supports both the glass retainer and the slider base, enhancing the structural integrity and stability of the assembly. This setup facilitates the objective of enabling precise adjustment of the glass without manual holding, ensuring a stable and secure fit.

According to an exemplary aspect of the present disclosure, the slider assembly includes a cam pre-assembled on the slider base, featuring multiple serrations that engage with corresponding serrations on the slider base. This design allows the cam to support the bottom edge of the glass effectively. By enabling controlled rotational movement, this mechanism ensures precise positioning of the glass, aligning with the objective to facilitate secure and stable positioning once the adjustment is made.

According to an exemplary aspect of the present disclosure, a spring tab is integrally connected to the glass retainer, applying a frictional force to hold the cam on the slider base under nominal conditions. This feature engages the serrations of both the cam and the slider base, locking the system to prevent unintended movements. This embodiment supports the objective of enhancing safety and reliability by ensuring the cam only rotates when adjustments are necessary, not due to external pressures or the glass's weight.

According to an exemplary aspect of the present disclosure, the spring tab releases the frictional force under operational conditions, allowing the cam to rotate freely by disengaging the serrations. This action enables manual adjustments of the glass position, supporting the objective of improving the ease of installation and maintenance. By allowing for easy engagement and disengagement, this mechanism simplifies the adjustment process while maintaining the precision and security of the glass positioning.

According to an exemplary aspect of the present disclosure, the back plate is configured to support the glass retainer and the slider base using a fastener that includes a bolt. This embodiment enhances the overall structural support of the assembly, contributing to the objective of optimizing the ergonomic design for user interaction. The use of a bolt-inclusive fastener ensures robust assembly, making the adjustment mechanism more user-friendly and intuitive.

According to an exemplary aspect of the present disclosure, the cam operation is manual, allowing users to control the glass adjustment by manually rotating the cam to engage or disengage the serrations with the slider base. This manual control mechanism facilitates precise and user-controlled adjustments, aligning with the objective of reducing wear and tear on components. By providing a smooth manual operation, this embodiment ensures that the components are less likely to experience excessive friction or damage over time.

According to an exemplary aspect of the present disclosure, the slider assembly is designed with a modular approach, allowing for easy customization and integration with various vehicle types. This embodiment supports the objective of providing a mechanism that can be adapted to different vehicle designs and specifications. The modular design enhances the versatility of the slider assembly, making it suitable for a wide range of frameless side window regulators and vehicle models.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a perspective view of the slider assembly, showing the overall arrangement of the slider base, glass retainer, and back plate. This view helps in understanding how these components are assembled to form the complete slider assembly for adjusting glass in frameless side window regulators.

FIG. 2 is an exploded view of the slider assembly, detailing each component including the slider base, glass retainer, back plate, cam, spring tab, and fasteners.

FIG. 3 is a detailed view showing the operation of the spring tab and cam within the slider assembly. This figure illustrates how the spring tab is bent upon manually applying force to the cam, which results in the disengagement of the cam's serrations from those on the slider base, facilitating the adjustment of the glass position in the frameless side window regulator.

FIG. 4 is a schematic representation showing the operation of the cam and spring tab in the slider assembly. It illustrates the nominal position and the adjusted position of the cam, demonstrating how the cam engages and disengages with the serrations on the slider base for adjusting the glass position.

FIG. 5 is a detailed view of the cam and slider base, showing the serrations which allow for the engagement and disengagement necessary to adjust the position of the glass. This view illustrates how the serrations on the cam interact with those on the slider base to facilitate precise and controlled movement of the cam during manual operation.

Furthermore, the objects and advantages of this invention will become apparent from the following description and the accompanying annexed drawings.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

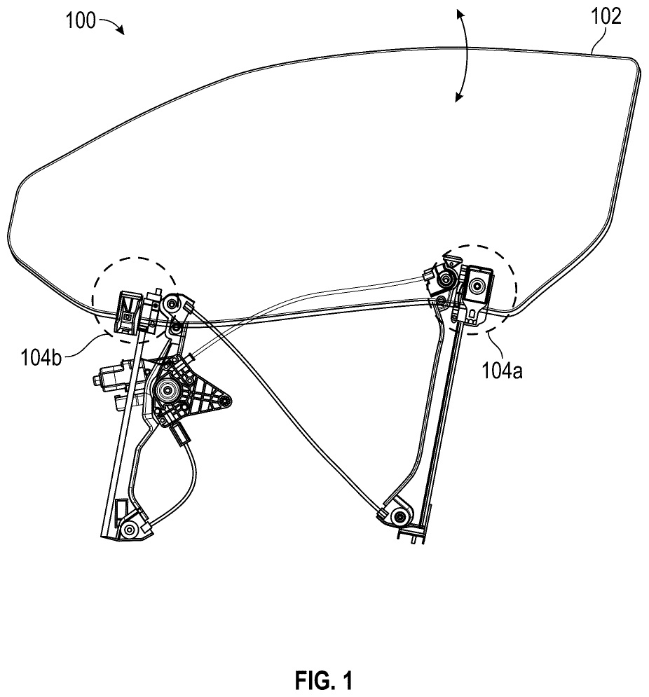

Referring to FIG. 1, a perspective view of the slider assembly is shown, illustrating the overall arrangement of its components in relation to the glass they are designed to adjust. The overall view, labeled 100, presents the entire setup, emphasizing how the slider assembly may be positioned with respect to the glass to facilitate precise and secure adjustments. The glass, labeled 102, is depicted to provide context on the interaction between the slider assembly and the glass within the frameless side window regulator. This helps in understanding how adjustments made by the slider assembly affect the glass's positioning and alignment.

In FIG. 1, the slider assembly, which facilitates the adjustment of glass in a frameless side window regulator, includes distinct configurations based on their positioning and functionality within the vehicle. The slider assembly with the glass adjustment feature, labeled 104a, is typically utilized on the aft side of the regulator. This assembly is specifically designed to enhance the adjustability of the glass, providing precise control over its positioning. On the fore side, the slider assembly with a typical glass clamp attachment, labeled 104b, is used, which standardizes the glass attachment process.

However, it is noteworthy that the slider assembly with the glass adjustment feature (104a) can also be utilized on both the fore and aft sides. This versatility allows for increased adjustability of the glass on both sides of the regulator, offering a more flexible and adaptable configuration. This dual-side capability enhances the overall functionality of the slider assembly, ensuring greater control and precision in glass positioning across different vehicle designs.

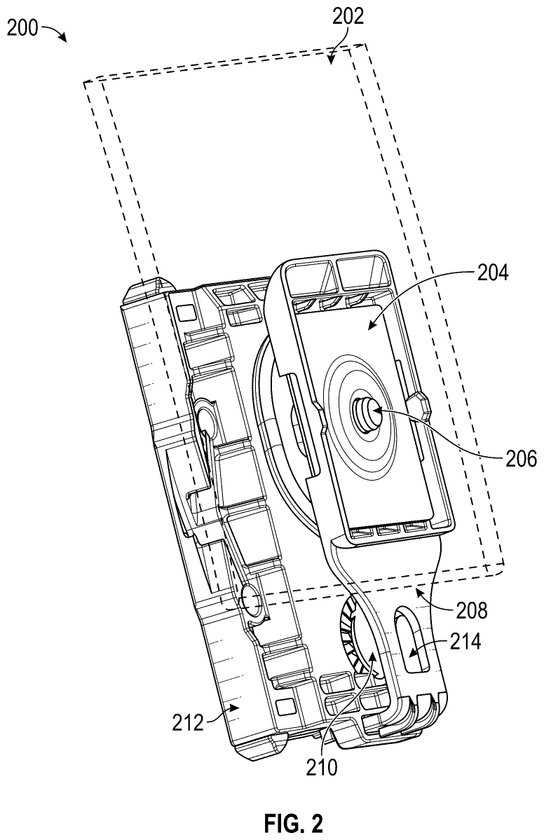

Referring to FIG. 2, an exploded view of the slider assembly is presented, illustrating the detailed configuration of each component that collectively adjusts and secures the glass in a frameless side window regulator. The overall view, labeled 200, depicts the entire assembly in a disassembled state to show how each part may be positioned relative to the others during assembly.

The glass, labeled 202, is shown to give context on how the slider assembly components interact with it to facilitate the adjustment process. This view helps to understand how the assembly supports and modifies the glass positioning within the window regulator framework. The back plate, labeled 204, is a crucial component that supports both the glass retainer and the slider base, enhancing the overall stability and structural integrity of the assembly. By distributing pressure and providing a stable platform, the back plate may prevent misalignment and ensure that the glass remains securely positioned during adjustments.

The glass attachment bolt, labeled 206, is used to secure the glass to the glass retainer. This bolt may play a vital role in maintaining the glass in a fixed position once the desired adjustment has been made, ensuring that the assembly holds the glass firmly against any operational stresses. The glass retainer, labeled 208, is designed to hold the glass securely and is attached to the slider base. It may conform to the contours of the glass, providing a secure grip that prevents slippage while allowing for controlled movement during the adjustment process.

The cam, labeled 210, is a key component pre-assembled on the slider base. It features multiple serrations that engage with those on the slider base to facilitate precise control over the glass's movement. By rotating the cam, the user may adjust the position of the glass with high precision, ensuring a perfect alignment with the vehicle's body seal. Finally, the slider base, labeled 212, forms the foundation of the slider assembly. It supports the glass retainer and interacts with the cam to provide a smooth and controlled adjustment mechanism. The slider base may be designed to facilitate easy movement of the cam while maintaining stability and alignment of the glass during adjustments. Additionally, the spring tab, labeled 214, is an integral component attached to the glass retainer. It plays a crucial role in the operation of the cam by applying and releasing frictional force, which aids in engaging or disengaging the cam's serrations with the slider base, thereby facilitating the manual adjustment of the glass position.

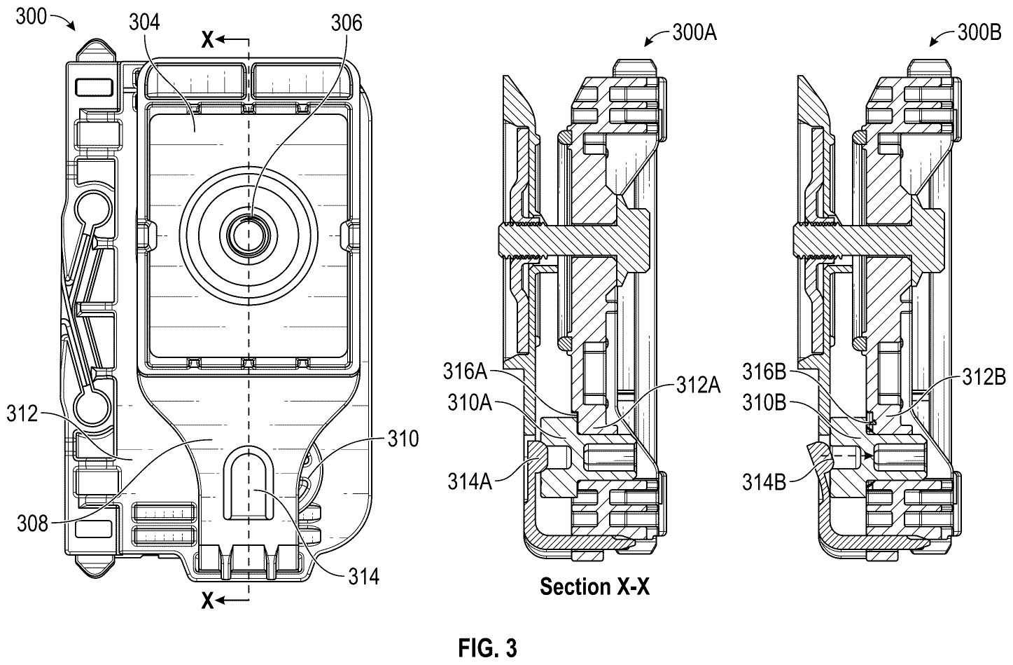

Referring to FIG. 3 presents a detailed view showcasing the operation of the spring tab and cam within the slider assembly, crucial for the manual adjustment of glass in a frameless side window regulator. The top view, labeled 300, provides a comprehensive overview of the entire slider assembly, illustrating the layout and arrangement of components, which clarifies the assembly's external design and spatial configuration.

The cross-sectional views further detail the functional states of the assembly. Label 300A shows the engaged condition, where the cam's serrations 316A are securely interlocked with the serrations on the slider base 312A, maintaining the glass in a stable and fixed position, supported by the back plate 304, glass retainer 308, and glass attachment bolt 306. This engagement ensures that the assembly holds the glass firmly, preventing any unintended movement.

The label 300B reveals the disengaged condition, initiated by manually applying force to the cam, which bends the spring tab 314. The condition of the bent spring tab is depicted in 314B. This action causes the serrations of the cam to disengage from those on the slider base, as seen in 310B and 316B, allowing for flexible adjustment of the glass's position. The bending of the spring tab and the resulting disengagement of the serrations are critical for enabling the user to precisely control and modify the glass alignment as required.

This detailed depiction in FIG. 3 illustrates not only the engaged and disengaged states of the slider assembly but also emphasizes the adjustability and user interaction required to achieve the desired glass positioning. The array of labels 310A, 310B, 314A, 314B, 316A, 316B helps clarify the roles of each component in these processes, highlighting how manual inputs lead to functional changes within the assembly, thereby supporting the overall functionality and flexibility of the window regulator system.

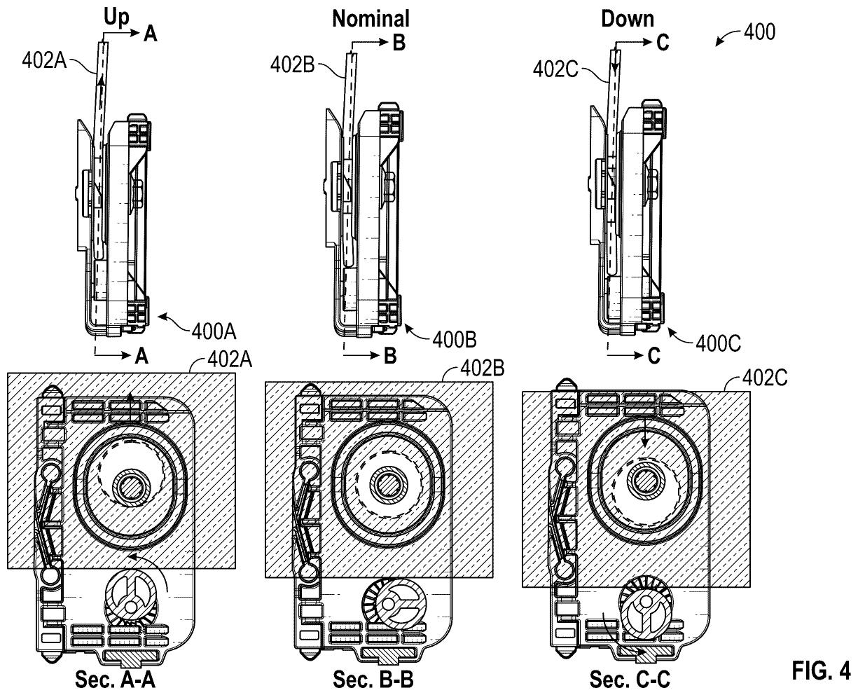

Referring to FIG. 4, a schematic representation is provided to show the operation of the cam and spring tab in the slider assembly, demonstrating how these components interact to adjust the position of the glass within the frameless side window regulator. The overall view, labeled 400, illustrates the entire schematic setup, highlighting the various positions the glass can achieve through the operation of the slider assembly.

The exemplary view labeled 400A depicts the position of the glass, labeled 402A, when it is adjusted up from the nominal condition. This adjustment showcases the ability to tailor the glass position to specific needs, emphasizing that the total amount and increments of glass movement can be adjusted by design, such as by varying the size of the cam and the configuration of the serrations. This view shows how the cam and spring tab work together to elevate the glass, providing a clearer understanding of the adjustments that can be made. The cam, through its engagement with the slider base, allows for precise upward movement, while the spring tab ensures that this adjusted position is securely maintained by applying the necessary frictional force.

In the view labeled 400B, the nominal condition of the glass, labeled 402B, is presented. This is the default position where the glass is neither elevated nor lowered, demonstrating the resting state of the cam and spring tab within the slider assembly. Here, the spring tab exerts a baseline frictional force that engages the cam with the slider base serrations, maintaining the glass in a stable and secure position.

Finally, the view labeled 400C shows the position of the glass, labeled 402C, when adjusted down from the nominal condition. Like the upward adjustment, the downward movement is also highly customizable. The design flexibility in the size of the cam and the configuration of the serrations allows for precise control over the positioning of the glass within the frameless side window regulator, ensuring that each adjustment is both precise and optimally suited to the specific requirements of the window system. This position illustrates the cam's capability to lower the glass precisely, facilitated by the cam rotating in the opposite direction. The spring tab adjusts its pressure to accommodate this downward movement, ensuring that the glass remains stable and securely positioned after the adjustment.

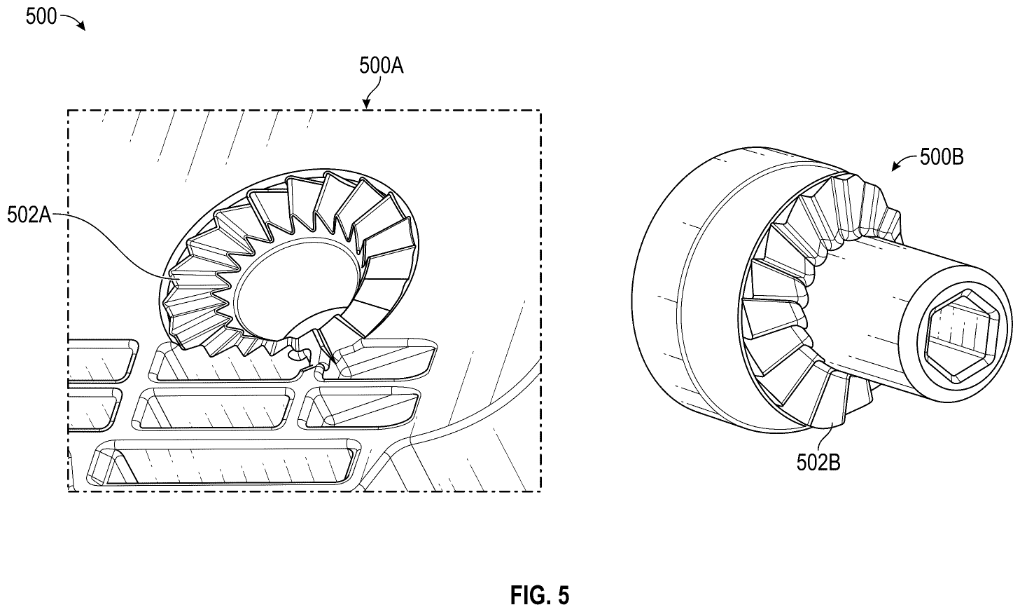

Referring to FIG. 5, a detailed view of the cam and slider base is presented, illustrating the serrations that are crucial for the engagement and disengagement processes which facilitate the precise adjustment of the glass in the frameless side window regulator. The overall view, labeled 500, offers a close-up perspective that highlights the intricate details of the serrations and how they interact to enable the manual control of glass positioning.

The exemplary view labeled 500A shows the serrations on the slider base, labeled 502A. This view provides a clear depiction of how these serrations are designed and arranged to allow for a secure and precise engagement with the cam. The serrations on the slider base are critical for maintaining the stability and position of the glass once adjusted. They are crafted to match perfectly with the cam's serrations, ensuring that each adjustment is smooth and consistent.

On the other hand, the exemplary view labeled 500B shows the serrations on the cam, labeled 502B. This view details how the serrations on the cam are shaped and positioned to engage with those on the slider base. The interaction between the cam's serrations and those on the slider base allows for controlled rotational movement of the cam, facilitating the adjustment of the glass's position. The precision of these serrations ensures that the cam can be securely locked in place or disengaged when necessary, providing the user with reliable control over the glass adjustment process.

According to the non-limiting exemplary embodiments of the present disclosure, the slider assembly is designed to adjust glass in frameless side window regulators, enabling precise and secure positioning. The assembly includes a slider base 212, a glass retainer 208, and a back plate 204. The glass retainer is connected to the slider base, ensuring that the glass 202 is securely held and can be smoothly adjusted. This connection supports the stability and alignment of the glass during the adjustment process.

The back plate is configured to support both the glass retainer and the slider base, enhancing the overall structural integrity of the assembly. This support allows the slider assembly to be effectively retained to the glass, ensuring that the system remains stable and functional under various operational conditions. A cam 210 is pre-assembled on the slider base, featuring multiple serrations that engage with corresponding serrations on the slider base. These serrations are crucial for supporting the bottom edge of the glass and facilitating precise adjustments.

The spring tab 314, integrally connected to the glass retainer, holds the cam on the slider base by applying a frictional force. Under nominal conditions, this frictional force keeps the cam engaged with the slider base's serrations, thereby locking the assembly in its current position and preventing any movement of the glass. When adjustments are needed, the operation of the cam involves the spring tab releasing this frictional force, which allows the cam to rotate freely. This rotation is facilitated by the disengagement of the serrations between the cam and the slider base, enabling the user to manually adjust the glass's position.

The serrations on the cam 502B and the slider base 502A are specifically configured to allow rotation in only one direction. This design prevents the cam from rotating due to the weight of the glass or any external pressures, ensuring that any adjustments made to the glass position remain intact until intentionally altered. This one-way rotation capability enhances the safety and reliability of the slider assembly by ensuring that the glass stays in its desired position once adjusted.

In another exemplary embodiment, the operation of the cam is entirely manual, which allows for user-controlled adjustment of the glass position within the frameless side window regulator. By manually rotating the cam, users can engage or disengage the serrations with the slider base, providing a tactile and precise control over the glass positioning. This manual control is ideal for making fine adjustments, ensuring that the glass aligns perfectly with the vehicle body for optimal performance and aesthetics.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A slider assembly for adjusting a glass in a frameless side window regulator, comprising:
a slider base, a glass retainer, and a back plate, wherein the glass retainer is connected to the slider base, and the back plate is configured to support both the glass retainer and the slider base, whereby the slider assembly is retained to the glass;
a cam pre-assembled on the slider base, wherein the cam and the slider base has multiple serrations configured to engage both the cam and the slider base in pre-assembled condition, thereby providing support to bottom edge of the glass; and
a spring tab integrally connected to the glass retainer that holds the cam on the slider base by frictional force, upon operating the cam, the spring tab releases the frictional force and pushes the cam to the slider base, thereby allowing the rotation of the cam and facilitating precise and secure positioning of the glass while adjusting the glass in the frameless side window regulator.

2. The slider assembly of the claim 1, wherein the serrations are configured to allow rotation in only one direction, thereby preventing the cam from rotating due to the weight of the glass.

3. The slider assembly of the claim 1, wherein the spring tab applies the frictional force under nominal conditions, thereby engaging the serrations of both the cam and the slider base.

4. The slider assembly of the claim 1, wherein the spring tab releases the frictional force under operational conditions, thereby allowing the cam to rotate by disengaging the serrations of both the cam and the slider base.

5. The slider assembly of claim 1, wherein the operation of the cam is manual, allowing for user-controlled adjustment of the glass position within the frameless side window regulator by manually rotating the cam to engage or disengage the serrations with the slider base, thereby facilitating the precise positioning of the glass.
